(19) United States
(12) Patent Application Publication
(10) Pub. No.: US 2022/0006359 A1
(43) Pub. Date: Jan. 6, 2022

(54) IN-WHEEL MOTOR AND ELECTRIC WHEEL

(71) Applicant: SONY CORPORATION, TOKYO (JP)

(72) Inventor: TAKASHI TAKAMATSU, TOKYO (JP)

(21) Appl. No.: 17/285,053

(22) PCT Filed: Oct. 17, 2019
(86) PCT No.: PCT/JP2019/040961

§ 371 Date: Apr. 13, 2021

(30) Foreign Application Priority Data
Oct. 23, 2018 (JP) 2018-199393

(51) Int. Cl. H02K 9/22; H02K 7/116; H02K 11/215; H02K 11/33

(52) U.S. Cl. CPC H02K 9/223; H02K 7/116; H02K 9/227; B62K 11/00; H02K 11/33; H02K 2211/03; B62K 2202/00; H02K 11/215

(57) ABSTRACT

An in-wheel motor includes a housing 32 that is supported by two support portions 14A and 14B on a rotation axis in an inner space of a wheel and includes a heat dissipation surface at at least one end portion thereof in a rotation axis direction, and a stator core 62 that is supported between the two support portions 14A and 14B and inside the housing 32 and has an inner peripheral surface to which a distance from the rotation axis is smaller than a distance from the rotation axis to an outer edge of the heat dissipation surface.

### FIELD

The present disclosure relates to an in-wheel motor and an electric wheel.

### BACKGROUND

A cooling structure of an in-wheel motor provided inside a wheel has been known. Patent Literature 1 discloses an example of a cooling structure of an in-wheel motor that directly cools the inside of the in-wheel motor by a coolant.

### CITATION LIST

### Patent Literature

Patent Literature 1: JP 2006-304543 A

### SUMMARY

### Technical Problem

However, the conventional technology described above has a problem that it is necessary to replenish the coolant. In addition, since a mechanism for circulating the coolant is required, there is a problem that a size and a weight are increased.

Therefore, the present disclosure proposes an in-wheel motor and an electric wheel capable of efficiently dissipating heat.

### Solution to Problem

To solve the problem described above, an in-wheel motor includes: a housing that is supported by two support portions on a rotation axis in an inner space of a wheel portion and includes a heat dissipation surface at at least one end portion thereof in the rotation axis direction; and a stator core that is supported between the two support portions and inside the housing and has an inner peripheral surface to which a distance from the rotation axis is smaller than a distance from the rotation axis to an outer edge of the heat dissipation surface.

### BRIEF DESCRIPTION OF DRAWINGS

FIG. 1 is a schematic view illustrating an example of a holding form of an electric wheel according to an embodiment of the present disclosure.

FIG. 2 is a cross-sectional view of the electric wheel according to the embodiment.

FIG. 3 is an exploded perspective view of the electric wheel according to the embodiment.

FIG. 4 is an exploded perspective view of the electric wheel according to the embodiment.

FIG. 5 is an exploded perspective view of the electric wheel according to the embodiment.

FIG. 6 is an exploded perspective view of the electric wheel according to the embodiment.

FIG. 7A is an exploded perspective view of the electric wheel according to the embodiment.

FIG. 7B is an exploded perspective view of the electric wheel according to the embodiment.

### DESCRIPTION OF EMBODIMENTS

Hereinafter, embodiments of the present disclosure will be described in detail with reference to the drawings. Note that in each of the following embodiments, the same portions will be denoted by the same reference numerals and an overlapping description thereof will be omitted.

[Structure of Electric Wheel According to Embodiment]

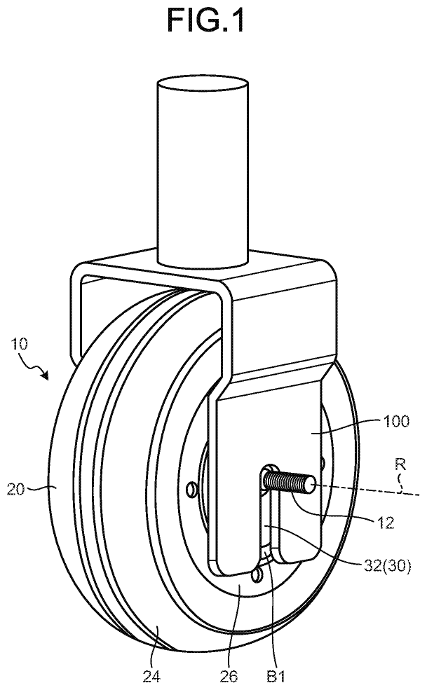

First, a configuration of an electric wheel 10 according to an embodiment of the present disclosure will be described. FIG. 1 is a schematic view illustrating an example of a holding form of an electric wheel according to an embodiment of the present disclosure. In the present disclosure, the electric wheel 10 is mounted on a vehicle having a structure in which both sides are open, such as a two-wheeled vehicle. The two-wheeled vehicle is assumed to be a small light vehicle such as an electric kickboard. The electric wheel 10 is a wheel having a diameter of 8 inches (204 mm), in the embodiment. The electric wheel 10 includes a wheel portion 20 and a drive device 30. The drive device 30 is an in-wheel motor provided inside the wheel portion 20. Fixed shafts 12 are fixed on both sides of the drive device 30. The fixed shafts 12 are coaxial with a rotation axis R of the wheel portion 20. The wheel portion 20 rotates with respect to the fixed shafts 12. The electric wheel 10 is held by a support member 100 via a support portion 14A and a support portion 14B of the fixed shafts 12. The support portion 14A and the support portion 14B are provided at inner end portions of the respective fixed shafts 12 in the embodiment. The support member 100 is a front fork of the two-wheeled vehicle, in the embodiment.

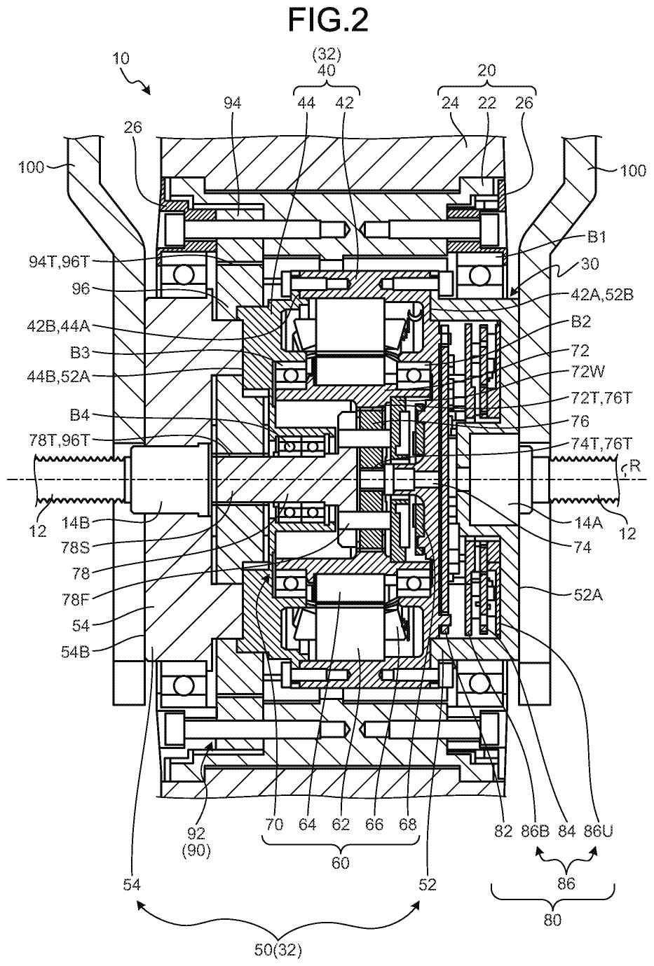

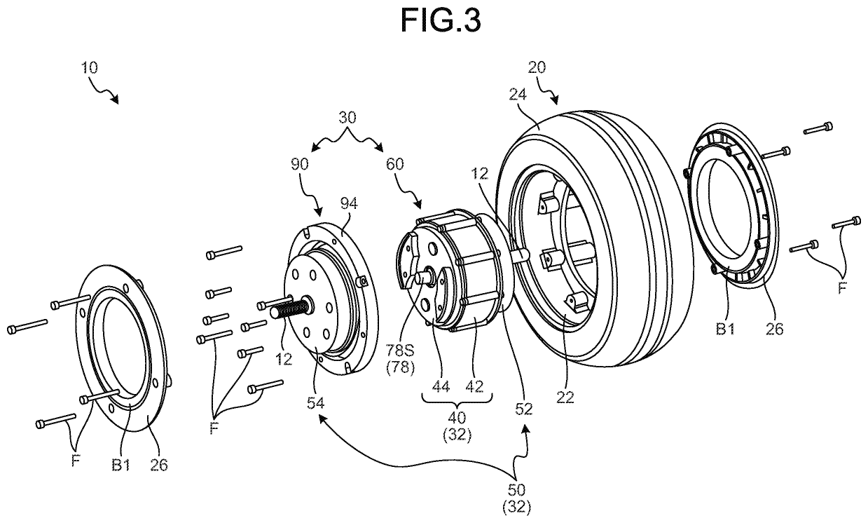

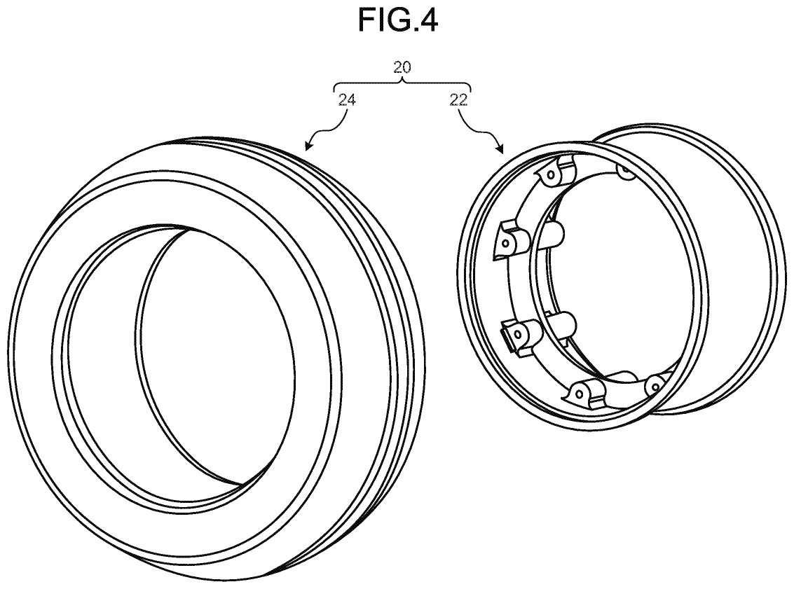

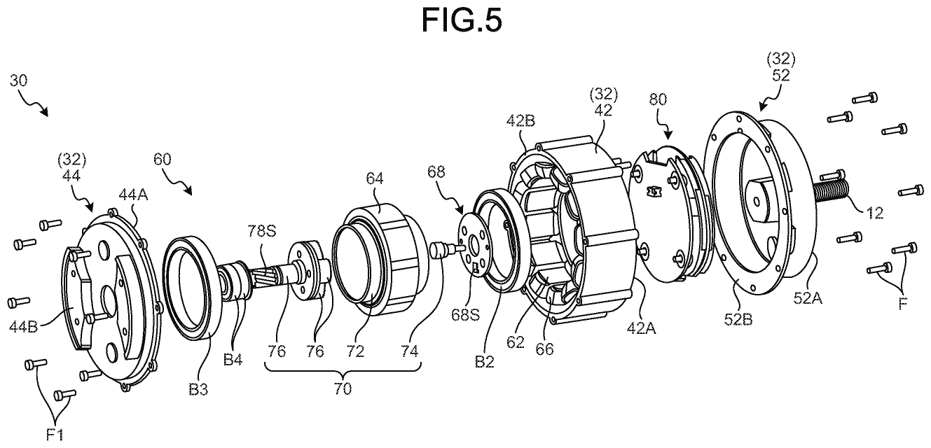

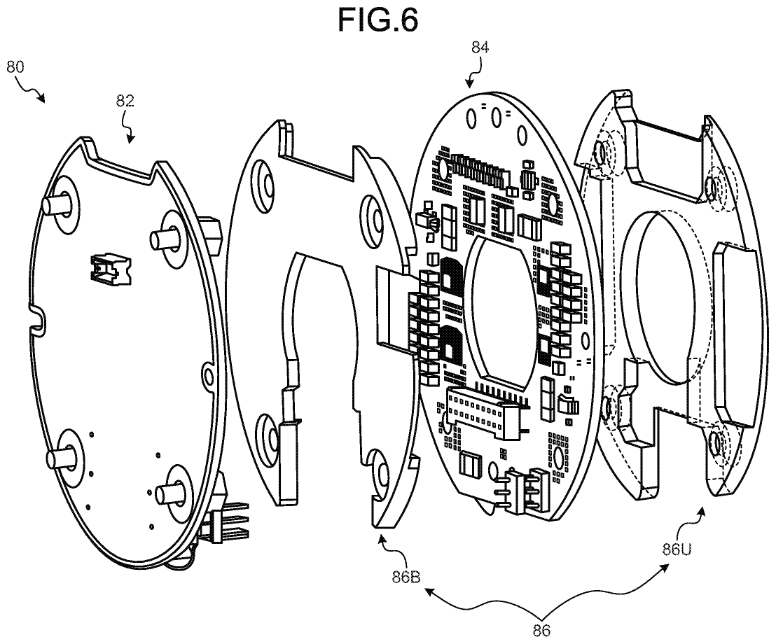

FIG. 2 is a cross-sectional view of the electric wheel according to the embodiment. FIGS. 3 to 7B are exploded perspective views of the electric wheels according to the embodiment. The wheel portion 20 includes a rim 22, a tire 24, two rim covers 26, and two first bearings B1. The drive device 30 includes a housing 32, a motor portion 60, a drive board 80, and a speed reducer 90.

The rim 22 has a cylindrical shape having the rotation axis R as a central axis. The rim 22 can be formed of, for example, a metal member such as an aluminum alloy. The drive device 30 is provided in an inner space of the rim 22.

The tire 24 is fitted to an outer side of the rim 22. The tire 24 can be formed of, for example, a member such as a synthetic resin. The tire 24 has a diameter of 8 inches (204 mm) and a width of 75 mm, in the embodiment.

The rim covers 26 are provided so as to cover both ends of the rim 22 in a rotation axis R direction, respectively. The rim cover 26 has an annular shape having substantially the same inner diameter as the rim 22. The rim cover 26 is fixed to the rim 22 by fixing members F such as bolts. The rim cover 26 can be formed of, for example, a member such as a synthetic resin.

The first bearings B1 are provided inside the rim covers 26, respectively. The first bearings B1 rotatably support the rim covers 26 and the rim 22 of the wheel portion 20 with respect to the housing 32 of the drive device 30.

The housing 32 is provided inside the rim 22, the rim cover 26, and the first bearing B1. The housing 32 is supported with respect to the support member 100 by the support portion 14A and the support portion 14B of the two fixed shafts 12. The housing 32 includes an inner housing 40 provided at a central portion in the rotation axis R direction and two outer housings 50 provided adjacent, respectively, to both sides of the inner housing 40 in the rotation axis R direction. The inner housing 40 includes a first inner housing 42 and a second inner housing 44. One of the two outer housings 50 is a first outer housing 52, and the other of the two outer housing 50 is a second outer housing 54.

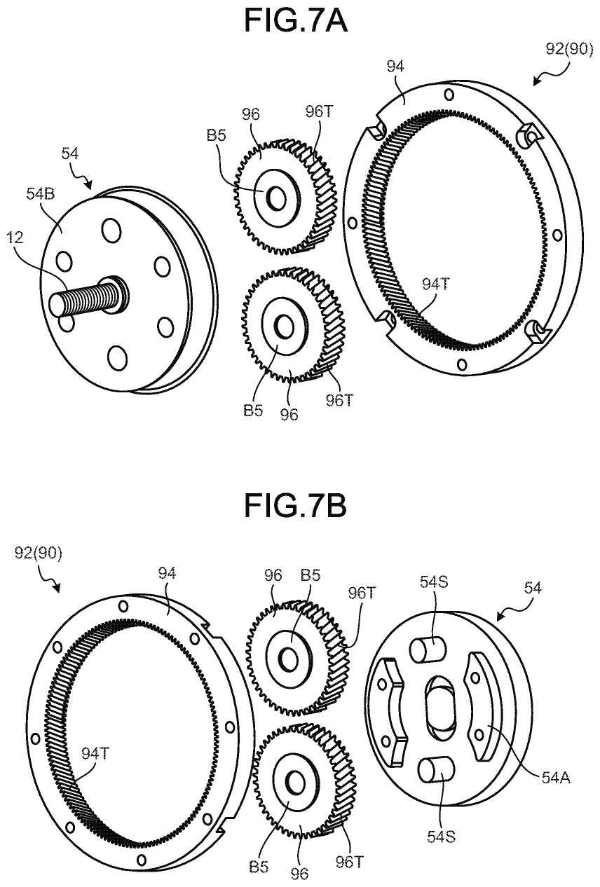

The first inner housing 42 is provided at a central portion in the rotation axis R direction inside the rim 22. An outer peripheral surface of the first inner housing 42 is provided so as to be spaced apart from an inner peripheral surface of the rim 22. The first inner housing 42 has a cylindrical shape having the rotation axis R as a central axis. The first inner housing 42 has an end surface 42A closing one end portion (right end portion in FIG. 7) thereof in the rotation axis R direction. The first inner housing 42 has an end surface 42B at an edge portion of an end portion thereof on a side opposite to the end surface 42A. The first inner housing 42 is formed of a member having high thermal conductivity. The first inner housing 42 can be formed of, for example, a metal such as an aluminum alloy and a copper alloy. The first inner housing 42 and the second inner housing 44 house the motor portion 60.

The second inner housing 44 is provided at a central portion in the rotation axis R direction inside the rim 22. An outer peripheral surface of the second inner housing 44 is provided so as to be spaced apart from the inner peripheral surface of the rim 22. The second inner housing 44 has a cylindrical shape having the rotation axis R as a central axis. The second inner housing 44 has a function as a lid closing an end portion of the first inner housing 42 on the end surface 42B side. The second inner housing 44 has a flange-shaped end surface 44A at an end portion thereof on the first inner housing 42 side. The end surface 44A is provided to be in surface-contact with the end surface 42B of the first inner housing 42. The second inner housing 44 has protruding portions 44B protruding to a side opposite to the end surface 44A. The second inner housing 44 is formed of a member having high thermal conductivity. The second inner housing 44 can be formed of, for example, a metal such as an aluminum alloy and a copper alloy. The second inner housing 44 and the first inner housing 42 house the motor portion 60.

The first outer housing 52 is provided adjacent to the inner housing 40 in the rotation axis R direction inside the first bearing B1. The first outer housing 52 is provided adjacent to the first inner housing 42, in the embodiment. The first outer housing 52 has a cylindrical shape having the rotation axis R as a central axis. The first outer housing 52 has a heat dissipation surface 52A at an end portion thereof on a side opposite to the first inner housing 42. A distance from the rotation axis R to an outer edge of the heat dissipation surface 52A is equal to a distance from the rotation axis R to an inner peripheral surface of the first bearing B1. In the embodiment, an outer diameter of the heat dissipation surface 52A is equal to an inner diameter of the first bearing B1. The heat dissipation surface 52A is provided to be in surface-contact with the support member 100. The first outer housing 52 has a flange-shaped end surface 52B at an end portion thereof on the first inner housing 42 side. The end surface 52B is provided to be in surface-contact with a part of the end surface 42A of the first inner housing 42. The first outer housing 52 is fixed to the first inner housing 42 by the fixing members F such as the bolts on the end surface 52B. The first outer housing 52 is fixed to the support portion 14A of the fixed shaft 12. The first outer housing 52 is formed of a member having high thermal conductivity. The first outer housing 52 can be formed of, for example, a metal such as an aluminum alloy and a copper alloy.

The second outer housing 54 is provided adjacent to the inner housing 40 in the rotation axis R direction inside the first bearing B1. The second outer housing 54 is provided adjacent to the second inner housing 44, in the embodiment. The second outer housing 54 has a cylindrical shape or a columnar shape having the rotation axis R as a central axis. The second outer housing 54 has protruding portions 54A protruding to the second inner housing 44 side. The protruding portions 54A are provided so as to be in surface-contact with the protruding portions 44B of the second inner housing 44. The second outer housing 54 has a heat dissipation surface 54B at an end portion thereof on a side opposite to the second inner housing 44. A distance from the rotation axis R to an outer edge of the heat dissipation surface 54B is equal to the distance from the rotation axis R to the inner peripheral surface of the first bearing B1. In the embodiment, an outer diameter of the heat dissipation surface 54B is equal to an inner diameter of the first bearing B1. The heat dissipation surface 54B is provided to be in surface-contact with the support member 100. The second outer housing 54 is provided to be in surface-contact with a part of the second inner housing 44. The second outer housing 54 is fixed to the support portion 14B of the fixed shaft 12. The second outer housing 54 is formed of a member having high thermal conductivity. The first outer housing 52 can be formed of, for example, a metal such as an aluminum alloy and a copper alloy. The second outer housing 54 has a function as a fixed support member of a speed reducer 90 to be described later. The second outer housing 54 has two columnar support shafts 54S protruding to the second inner housing 44 side at a position different from the protruding portion 54A. The support shaft 54S supports a central shaft of a planetary gear 96 of a speed reducer 90 to be described later.

The motor portion 60 is housed in the first inner housing 42 and the second inner housing 44. The motor portion 60 includes a stator core 62, a rotor 64, a motor coil 66, an encoder board 68, and a first planetary gear mechanism 70. The first planetary gear mechanism 70 includes a rotor internal gear 72, a sun gear 74, four planetary gears 76, a rotation support member 78, a second bearing B2, a third bearing B3, and a fourth bearing B4.

The stator core 62 has a cylindrical shape having the rotation axis R as a central axis. A distance from the rotation axis R to an inner peripheral surface of the stator core 62 is smaller than the distance from the rotation axis R to the outer edge of the heat dissipation surface 52A of the first outer housing 52. An inner diameter of the stator core 62 is smaller than the outer diameter of the heat dissipation surface 52A of the first outer housing 52, in the embodiment. The distance from the rotation axis R to the inner peripheral surface of the stator core 62 is smaller than the distance from the rotation axis R to the outer edge of the heat dissipation surface 54B of the second outer housing 54. The inner diameter of the stator core 62 is smaller than the outer diameter of the heat dissipation surface 54B of the second outer housing 54, in the embodiment. The stator core 62 is provided to be fitted to an inner side of the first inner housing 42. An outer peripheral surface of the stator core 62 and an inner peripheral surface of the first inner housing 42 are provided to be in surface-contact with each other. The stator core 62 is formed of an electromagnetic steel plate. The stator core 62 can be formed of, for example, iron, nickel, and cobalt.

The rotor 64 has a cylindrical shape having the rotation axis R as a central axis. The rotor 64 is provided inside the stator core 62. The rotor 64 has magnets evenly embedded on a circumference of the rotor 64.

The motor coil 66 is wound between a plurality of grooves formed in the stator core 62. An electromagnetic force is generated between the stator core 62 and the rotor 64 by a current flowing through the motor coil 66, such that the rotor 64 rotates around the rotation axis R.

The rotor internal gear 72 has a cylindrical shape having the rotation axis R as a central axis. The rotor internal gear 72 is provided to be fitted to an inner side of the rotor 64. A width of the rotor internal gear 72 in the rotation axis R direction is larger than a width of the rotor 64 in the rotation axis R direction. The rotor internal gear 72 is rotatably supported with respect to the first inner housing 42 via the second bearing B2. The rotor internal gear 72 rotates integrally with the rotor 64. The rotor internal gear 72 is rotatably supported with respect to the second inner housing 44 via the third bearing B3. The rotor internal gear 72 has a tooth portion 72T on a part of an inner peripheral surface thereof. The rotor internal gear 72 has a wall portion 72W extending from the inner peripheral surface to the rotation axis R side, on a side closer to the first outer housing 52 than the tooth portion 72T is.

The sun gear 74 has the rotation axis R as a central axis. The sun gear 74 is provided inside the rotor internal gear 72. The sun gear 74 is fixedly provided on the end surface 42A side of the first inner housing 42. The sun gear 74 has a tooth portion 74T on a part of an outer peripheral surface thereof.

The four planetary gears 76 are evenly provided on an outer circumference of the sun gear 74. The planetary gears 76 are provided between the tooth portion 72T of the rotor internal gear 72 and the tooth portion 74T of the sun gear 74, respectively. The planetary gears 76 have tooth portions 76T on outer peripheral surfaces thereof. The tooth portions 76T of the planetary gears 76 are engaged with the tooth portion 72T of the rotor internal gear 72 and the tooth portion 74T of the sun gear 74, respectively. The planetary gears 76 revolve around the sun gear 74 in the same direction while rotating in the same direction as the rotor internal gear 72 along with rotation of the rotor internal gear 72. The four planetary gears 76 are provided in the embodiment, but the number of planetary gears 76 is not limited to four.

The rotation support member 78 has the rotation axis R as a central axis. The rotation support member 78 is rotatably supported with respect to the second inner housing 44 via the fourth bearing B4. The rotation support member 78 has a support shaft 78F for fixing the planetary gear 76. The rotation support member 78 rotates along with the revolution of the planetary gear 76. The rotation support member 78 is provided integrally with an output shaft 78S of the motor portion 60. The output shaft 78S is provided so as to protrude from an end surface of the second inner housing 44 on the second outer housing 54 side. The output shaft 78S has a tooth portion 78T on an outer peripheral surface thereof. The output shaft 78S has a function as a sun gear of a speed reducer 90 to be described later.

The encoder board 68 has a disk shape orthogonal to the rotation axis R. The encoder board 68 is fixedly provided in the first inner housing 42 inside the rotor internal gear 72 and on a side closer to the first outer housing 52 than the wall portion 72W is. The encoder board 68 is provided with a sensor integrated circuit 68C on a surface thereof on the wall portion 72W side. The sensor integrated circuit 68C is a magnetic rotation detection sensor. The sensor integrated circuit 68C detects the number of rotations and a rotation speed of the rotor internal gear 72. The rotor internal gear 72 rotates integrally with the rotor 64. Therefore, the sensor integrated circuit 68C can detect the number of rotations and a rotation speed of the rotor 64 by detecting the number of rotations and the rotation speed of the rotor internal gear 72. The sensor integrated circuit 68C is shielded from magnetism generated by the rotor 64 by the wall portion 72W. Therefore, the encoder board 68 can be provided inside the rotor 64, which can contribute to miniaturization of the drive device 30.

The drive board 80 is provided inside the first outer housing 52. The drive board 80 is provided to be spaced apart from the motor portion 60 housed in the first inner housing 42 and the second inner housing 44. The drive board 80 includes a first board 82, a second board 84, and two heat diffusion plates 86. The drive board 80 has a two-story structure in which the first board 82 and the second board 84 are arranged in parallel, in the embodiment. The drive board 80 may be provided by one sheet, but it is possible to contribute to miniaturization of the drive device 30 and the electric wheel 10 by making the drive board 80 the two-story structure. In addition, the drive board 80 may be provided outside the housing 32. For example, the drive board 80 may be provided inside another housing attached to a frame of the two-wheeled vehicle on which the electric wheel 10 is mounted. In a case where the drive board 80 is not provided in the housing 32, the first inner housing 42 and the first outer housing 52 may be provided integrally with each other.

The first board 82 has a disk shape orthogonal to the rotation axis R. The first board 82 includes an arithmetic processing unit that controls the drive of the motor portion 60 on the basis of a predetermined arithmetic program. The arithmetic processing unit controls the drive of the motor portion 60 on the basis of the number of rotations and the rotation speed of the rotor internal gear 72 detected by the sensor integrated circuit 68C of the encoder board 68. The arithmetic processing unit is, for example, a central processing unit (CPU).

The second board 84 has a disk shape orthogonal to the rotation axis R. The second board 84 includes a power control unit that controls power energizing the motor coil 66. The power control unit of the second board 84 includes a power semiconductor. The second board 84 is provided on a side closer to the heat dissipation surface 52A than the first board 82 is.

The heat diffusion plate 86 is an integrated heat spreader. The integrated heat spreader has a structure that diffuses heat to enhance a heat dissipation effect. The heat diffusion plate 86 includes a first heat diffusion plate 86B and a second heat diffusion plate 86U. The first heat diffusion plate 86B is provided between the first board 82 and the second board 84. The second heat diffusion plate 86U is provided more adjacent to the heat dissipation surface 52A side of the first outer housing 52 than the second board 84 is. At least a part of the second heat diffusion plate 86U is in surface-contact with and fixed to an inner side of the first outer housing 52. The heat diffusion plate 86 is formed of a member having high thermal conductivity. The heat diffusion plate 86 can be formed of, for example, a metal such as an aluminum alloy and a copper alloy.

The speed reducer 90 includes a second planetary gear mechanism 92. The second planetary gear mechanism 92 includes the output shaft 78S of the rotation support member 78, an internal gear 94, two planetary gears 96, the second outer housing 54, and a fifth bearing B5. The output shaft 78S has a function as a sun gear in the second planetary gear mechanism 92. The second outer housing 54 has a function as a fixed support member in the second planetary gear mechanism 92.

The internal gear 94 has a cylindrical shape having the rotation axis R as a central axis. The internal gear 94 has substantially the same inner diameter as the rim 22. The internal gear 94 is provided between the second inner housing 44 and the second outer housing 54 in the rotation axis R direction. The internal gear 94 is fixed to the rim 22 by the fixing members F such as the bolts. The internal gear 94 has a tooth portion 94T on an inner peripheral surface thereof.

The planetary gear 96 has a disk shape having a through hole in the center thereof. The two planetary gears 96 are provided point-symmetrically on an outer circumference of the output shaft 78S. The planetary gears 96 are provided between the tooth portion 94T of the internal gear 94 and the tooth portion 78T of the output shaft 78S, respectively. The planetary gears 96 have tooth portions 96T on outer peripheral surfaces thereof. The tooth portions 96T of the planetary gears 96 are engaged with the tooth portion 94T of the internal gear 94 and the tooth portion 78T of the output shaft 78S, respectively. The fifth bearing B5 is provided inside the planetary gear 96. The planetary gear 96 is fixed to the support shaft 54S of the second outer housing 54 via the fifth bearing B5. The planetary gear 96 rotates in a direction opposite to that of the output shaft 78S along with rotation of the output shaft 78S. The internal gear 94 and the rim 22 rotate in the direction opposite to the output shaft 78S along with the rotation of the planetary gear 96. The number of planetary gears 96 is not limited to two, and may be three or more. The protruding portions 44B of the second inner housing 44 and the protruding portions 54A of the second outer housing 54 can be provided larger in a case where the number of planetary gears 96 is two than in a case where the number of planetary gears 96 is three or more.

[Heat Transfer Path of Electric Wheel According to Embodiment]

Next, a heat transfer path in the drive device 30 and the electric wheel 10 according to the embodiment of the present disclosure will be described with reference to FIG. 2. When the motor coil 66 is energized under the control of the drive board 80, Joule heat is generated by electric resistance of the motor coil 66. That is, a main heat transfer source of the drive device 30 is the motor coil 66. As illustrated in FIG. 2, the motor coil 66 is arranged substantially at the center of the electric wheel 10 in the rotation axis R direction. In the drive device 30 and the electric wheel 10 according to the present disclosure, the heat is dissipated from the heat dissipation surfaces 52A and the heat dissipation surfaces 54B provided, respectively, at both end portions of the housing 32 in the rotation axis R direction.

First, a heat transfer path from the motor coil 66 to the first inner housing 42 will be described. The motor coil 66 is wound around the stator core 62. Therefore, the stator core 62 receives the heat from the motor coil 66, which is a heat transfer source. The outer peripheral surface of the stator core 62 and the inner peripheral surface of the first inner housing 42 are provided to be in surface-contact with each other. In addition, the first inner housing 42 is formed of the member having the high thermal conductivity. Therefore, the heat transferred to the stator core 62 is transferred to the first inner housing 42.

Next, a heat transfer path from the first inner housing 42 to the heat dissipation surface 52A will be described. The end surface 42A of the first inner housing 42 and the end surface 52B of the first outer housing 52 are provided to be in surface-contact with each other. The end surface 52B of the first outer housing 52 is provided in a flange shape at the end portion on the first inner housing 42 side to enlarge a contact surface with the end surface 42A of the first inner housing 42. In addition, the first outer housing 52 is formed of the member having the high thermal conductivity. Therefore, the heat transferred to the first inner housing 42 is efficiently transferred to the first outer housing 52.

The heat dissipation surface 52A of the first outer housing 52 and the support member 100 are provided to be in surface-contact with each other. Therefore, the heat transferred to the first outer housing 52 is dissipated to the support member 100 via the heat dissipation surface 52A. In a case of a configuration in which the support member 100 is not in surface-contact with the heat dissipation surface 52A, the heat is dissipated directly from the heat dissipation surface 52A to outside air. The outer diameter of the heat dissipation surface 52A is equal to the inner diameter of the first bearing B1 and is larger than the inner diameter of the stator core 62. The heat can be efficiently dissipated by enlarging the heat dissipation surface 52A.

Next, a heat transfer path from the first inner housing 42 to the heat dissipation surface 54B will be described. The end surface 42B of the first inner housing 42 and the end surface 44A of the second inner housing 44 are provided to be in surface-contact with each other. The end surface 44A of the second inner housing 44 is provided in a flange shape at the end portion on the first inner housing 42 side to enlarge a contact surface with the end surface 42B of the first inner housing 42. In addition, the second inner housing 44 is formed of the member having the high thermal conductivity. Therefore, the heat transferred to the first inner housing 42 is efficiently transferred to the second inner housing 44.

The protruding portions 44B of the second inner housing 44 and the protruding portions 54A of the second outer housing 54 are provided to be in surface-contact with each other. In the embodiment, the number of planetary gears 96 provided between the second outer housing 54 and the second inner housing 44 is two. Therefore, the protruding portions 44B of the second inner housing 44 and the protruding portions 54A of the second outer housing 54 can be provided large, and contact surfaces between the protruding portions 44B and the protruding portions 54A can thus be enlarged. Therefore, the heat transferred to the second inner housing 44 is efficiently transferred to the second outer housing 54.

The heat dissipation surface 54B of the second outer housing 54 and the support member 100 are provided to be in surface-contact with each other. Therefore, the heat transferred to the second outer housing 54 is dissipated to the support member 100 via the heat dissipation surface 54B. In a case of a configuration in which the support member 100 is not in surface-contact with the heat dissipation surface 54B, the heat is dissipated directly from the heat dissipation surface 54B to outside air. The outer diameter of the heat dissipation surface 54B is equal to the inner diameter of the first bearing B1 and is larger than the inner diameter of the stator core 62. The heat can be efficiently dissipated by enlarging the heat dissipation surface 54B.

As described above, in the drive device 30 and the electric wheel 10 according to the present disclosure, the heat is dissipated from the drive board 80 side and the speed reducer 90 side that are positioned on the outermost side in the housing 32 housing the motor coil 66. Then, by enlarging areas of the heat dissipation surface 52A on the drive board 80 side and the heat dissipation surface 54B on the speed reducer 90 side, the heat can be efficiently dissipated. Since a cooling component is not required for the heat dissipation, maintenance such as replacement and replenishment of the cooling component is unnecessary. In the embodiment, the heat is transferred to both sides of the housing 32 and is dissipated from both of the heat dissipation surface 52A and the heat dissipation surface 54B, which are both end portions of the housing 32, and the heat can thus be dissipated more efficiently. Since heat transfer paths from the stator core 62 to the heat dissipation surface 52A and the heat dissipation surface 54B are connected by a continuous solid member without an air layer having a low heat transfer coefficient, the heat can be efficiently transferred to the heat dissipation surface 52A and the heat dissipation surface 54B. Further, the first inner housing 42, the first outer housing 52, the second inner housing 44, and the second outer housing 54 constituting the heat transfer paths are formed of members having high thermal conductivity, and the heat can thus be transferred efficiently.

When the motor coil 66 is energized under the control of the drive board 80, Joule heat is generated in the first board 82 and the second board 84 due to the electrical resistance. The first board 82 transfers the heat to the first heat diffusion plate 86B. The second board 84 transfers the heat to the first heat diffusion plate 86B and the second heat diffusion plate 86U. The first heat diffusion plate 86B and the second heat diffusion plate 86U diffuse the heat to enhance a heat dissipation effect. The second heat diffusion plate 86U and the inner side of the first outer housing 52 are provided to be in partial surface-contact with each other. Therefore, the heat transferred to the second heat diffusion plate 86U is transferred to the first outer housing 52. The heat transferred to the second outer housing 54 is dissipated to the support member 100 via the heat dissipation surface 54B. The drive board 80 generates more heat in the second board 84 controlling the power. By providing the second board 84 on a side closer to the heat dissipation surface 52A than the first board 82 is, the heat can be efficiently dissipated. In addition, by providing the second board 84 so as to be spaced apart from the motor coil 66, which is the main heat transfer source, a temperature rise can be suppressed.

Each of the embodiments of the present disclosure has been described hereinabove, but the technical scope of the present disclosure is not limited to each of the embodiments described above, and various modifications can be made without departing from the gist of the present disclosure.

A case where it has been assumed that the heat is dissipated from both of the heat dissipation surface 52A and the heat dissipation surface 54B provided, respectively, at both end portions of the housing 32 in the rotation axis R direction has been described in the embodiment described above, but the present disclosure is not limited thereto. The heat dissipation surface may be provided on only one side of the housing 32.

A case where it has been assumed that the first inner housing 42 is provided in the cylindrical shape and the second inner housing 44 has the function as the lid of the first inner housing 42 has been described in the embodiment described above, but the present disclosure is not limited thereto, and, for example, the second inner housing 44 may be provided in a cylindrical shape and the stator core 62 may be provided to be fitted to an inner side of the second inner housing 44. In this case, the heat transferred from the motor coil 66 to the stator core 62 is first transferred to the second inner housing 44, and is then transferred to the first inner housing 42 and the second outer housing 54.

A case where it has been assumed that the heat transfer path is entirely composed of the solid member has been described in the embodiment described above, but the present disclosure is not limited thereto. For example, at least a part of the housing 32 may be filled with an insulating heat dissipating agent in order to increase the heat transfer path or fill a minute gap due to assembly. The insulating heat dissipating agent is, for example, grease mixed with particles having high thermal conductivity.

Note that effects described in the present specification are merely examples and are not limited, and other effects may be provided.

Note that the present technology can also have the following configuration.

(1)

An in-wheel motor comprising:

a housing that is supported by two support portions on a rotation axis in an inner space of a wheel portion and includes a heat dissipation surface at at least one end portion thereof in the rotation axis direction; and

a stator core that is supported between the two support portions and inside the housing and has an inner peripheral surface to which a distance from the rotation axis is smaller than a distance from the rotation axis to an outer edge of the heat dissipation surface.

(2)

The in-wheel motor according to (1), wherein

the in-while motor has a solid heat transfer path that is continuous from the stator core to the heat dissipation surface.

(3)

The in-wheel motor according to (1) or (2), wherein

the housing includes heat dissipation surfaces at both end portions thereof in the rotation axis direction.

(4)

The in-wheel motor according to any one of (1) to (3), wherein

the stator core is supported by having an outer peripheral surface in surface-contact with an inner peripheral surface of the housing.

(5)

The in-wheel motor according to any one of (1) to (4), comprising

a drive board that is housed inside the housing and controls an electromagnetic force generated in the stator core.

(6)

The in-wheel motor according to (5), wherein

the drive board includes a first board including an arithmetic processing unit that executes a predetermined arithmetic program and a second board provided on a side closer to the heat dissipation surface than the first board is and including a power control unit that controls power.

(7)

The in-wheel motor according to (6), wherein

the drive board includes a heat diffusion plate provided more adjacent to the heat dissipation surface side than the second board is, and at least a part of the drive board is in surface-contact with and fixed to an inner side of the housing.

(8)

The in-wheel motor according to any one of (5) to (7), wherein

the housing includes an inner housing that houses the stator core and a first outer housing that houses the drive board and includes the heat dissipation surface.

(9)

The in-wheel motor according to (8), wherein

the first outer housing is in surface-contact with and fixed to an end surface of the inner housing in the rotation axis direction.

(10)

The in-wheel motor according to (8) or (9), comprising

a speed reducer that is provided on a side opposite to the drive board with respect to the stator core and includes the heat dissipation surface.

(11)

The in-wheel motor according to (10), wherein

the speed reducer includes:

an output shaft that protrudes outwardly of the inner housing and outputs a rotation of a rotor that rotates by magnetism of the stator core;

an internal gear that is fixed to the wheel portion; and

a planetary gear that is engaged with the output shaft and the internal gear, and

the housing includes a second outer housing that is provided on a side opposite to the first outer housing with respect to the inner housing, supports a rotation shaft of the planetary gear, and includes the heat dissipation surface.

(12)

The in-wheel motor according to (11), wherein

the number of planetary gears is two.

(13)

The in-wheel motor according to (11) or (12), wherein

the second outer housing is provided to be in surface-contact with at least a part of an end portion of the inner housing in the rotation axis direction.

(14)

The in-wheel motor according to any one of (1) to (13), comprising:

a sensor integrated circuit that is supported inside a rotor that rotates by magnetism of the stator core and detects the rotation of the rotor; and

a wall that blocks the magnetism of the stator core and the rotor from the sensor integrated circuit.

(15)

An electric wheel including:

a housing that includes a heat dissipation surface at at least one end portion thereof in a rotation axis direction;

two fixed shafts that are coaxial with the rotation axis and support the housing;

a stator core that is supported inside the housing and has an inner peripheral surface to which a distance from the rotation axis is smaller than a distance from the rotation axis to an outer edge of the heat dissipation surface; and a wheel portion that houses the housing in an inner space thereof and rotates around the rotation axis.

(16)

The electric wheel according to (15), wherein

the heat dissipation surface is in surface-contact with and fixed to a support member holding the fixed shaft.

(17)

The electric wheel according to (15) or (16), wherein

the wheel portion is connected to an outer peripheral surface of the housing via a bearing at an end portion thereof in a rotation axis direction, and

the distance from the rotation axis to the outer edge of the heat dissipation surface is equal to a distance from the rotation axis to an inner peripheral surface of the bearing.

### REFERENCE SIGNS LIST

10 ELECTRIC WHEEL
12 FIXED SHAFT
14A, 14B Support Portion
20 WHEEL PORTION
30 DRIVE DEVICE
32 HOUSING
40 INNER HOUSING
42 FIRST INNER HOUSING
42A, 42B END SURFACE
44 SECOND INNER HOUSING
44A END SURFACE
44B PROTRUDING PORTION
50 OUTER HOUSING
52 FIRST OUTER HOUSING
52A HEAT DISSIPATION SURFACE
52B END SURFACE
54 SECOND OUTER HOUSING
54A PROTRUDING PORTION
54B HEAT DISSIPATION SURFACE
60 MOTOR PORTION
62 STATOR CORE
64 ROTOR
66 MOTOR COIL
68 ENCODER BOARD
68C SENSOR INTEGRATED CIRCUIT
70 FIRST PLANETARY GEAR MECHANISM
72 ROTOR INTERNAL GEAR
72W WALL PORTION
74 SUN GEAR
76 PLANETARY GEAR
78 ROTATION SUPPORT MEMBER
78S OUTPUT SHAFT
80 DRIVE BOARD
82 FIRST BOARD
84 SECOND BOARD
86 HEAT DIFFUSION PLATE
90 SPEED REDUCER
92 SECOND PLANETARY GEAR MECHANISM
94 INTERNAL GEAR
96 PLANETARY GEAR
100 SUPPORT MEMBER
R ROTATION AXIS

1. An in-wheel motor comprising:
a housing that is supported by two support portions on a rotation axis in an inner space of a wheel portion and includes a heat dissipation surface at at least one end portion thereof in the rotation axis direction; and
a stator core that is supported between the two support portions and inside the housing and has an inner peripheral surface to which a distance from the rotation axis is smaller than a distance from the rotation axis to an outer edge of the heat dissipation surface.

2. The in-wheel motor according to claim 1, wherein
the in-while motor has a solid heat transfer path that is continuous from the stator core to the heat dissipation surface.

3. The in-wheel motor according to claim 1, wherein
the housing includes heat dissipation surfaces at both end portions thereof in the rotation axis direction.

4. The in-wheel motor according to claim 1, wherein
the stator core is supported by having an outer peripheral surface in surface-contact with an inner peripheral surface of the housing.

5. The in-wheel motor according to claim 1, comprising
a drive board that is housed inside the housing and controls an electromagnetic force generated in the stator core.

6. The in-wheel motor according to claim 5, wherein
the drive board includes a first board including an arithmetic processing unit that executes a predetermined arithmetic program and a second board provided on a side closer to the heat dissipation surface than the first board is and including a power control unit that controls power.

7. The in-wheel motor according to claim 6, wherein
the drive board includes a heat diffusion plate provided more adjacent to the heat dissipation surface side than the second board is, and at least a part of the drive board is in surface-contact with and fixed to an inner side of the housing.

8. The in-wheel motor according to claim 5, wherein
the housing includes an inner housing that houses the stator core and a first outer housing that houses the drive board and includes the heat dissipation surface.

9. The in-wheel motor according to claim 8, wherein
the first outer housing is in surface-contact with and fixed to an end surface of the inner housing in the rotation axis direction.

10. The in-wheel motor according to claim 8, comprising
a speed reducer that is provided on a side opposite to the drive board with respect to the stator core and includes the heat dissipation surface.

11. The in-wheel motor according to claim 10, wherein
the speed reducer includes:
an output shaft that protrudes outwardly of the inner housing and outputs a rotation of a rotor that rotates by magnetism of the stator core;
an internal gear that is fixed to the wheel portion; and
a planetary gear that is engaged with the output shaft and the internal gear, and
the housing includes a second outer housing that is provided on a side opposite to the first outer housing with respect to the inner housing, supports a rotation shaft of the planetary gear, and includes the heat dissipation surface.

12. The in-wheel motor according to claim 11, wherein
the number of planetary gears is two.

13. The in-wheel motor according to claim 11, wherein
the second outer housing is provided to be in surface-contact with at least a part of an end portion of the inner housing in the rotation axis direction.

14. The in-wheel motor according to claim 1, comprising:
a sensor integrated circuit that is supported inside a rotor that rotates by magnetism of the stator core and detects the rotation of the rotor; and
a wall that blocks the magnetism of the stator core and the rotor from the sensor integrated circuit.

15. An electric wheel comprising:
a housing that includes a heat dissipation surface at at least one end portion thereof in a rotation axis direction;
two fixed shafts that are coaxial with the rotation axis and support the housing;
a stator core that is supported between the two fixed shafts and inside the housing and has an inner peripheral surface to which a distance from the rotation axis is smaller than a distance from the rotation axis to an outer edge of the heat dissipation surface; and
a wheel portion that houses the housing in an inner space thereof and rotates around the rotation axis.

16. The electric wheel according to claim 15, wherein
the heat dissipation surface is in surface-contact with and fixed to a support member holding the fixed shaft.

17. The electric wheel according to claim 15, wherein
the wheel portion is connected to an outer peripheral surface of the housing via a bearing at an end portion thereof in a rotation axis direction, and
the distance from the rotation axis to the outer edge of the heat dissipation surface is equal to a distance from the rotation axis to an inner peripheral surface of the bearing.
